(19) United States
(12) Patent Application Publication
(10) Pub. No.: US 2015/0318553 A1
(43) Pub. Date: Nov. 5, 2015

(54) COMPOSITE MATERIAL, METHOD OF PRODUCTION THEREOF, SYSTEM PRODUCED THEREFROM AND APPLICATION OF SAME

(71) Applicant: VARTA MICROBATTERY GMBH, Ellwangen (DE)

(72) Inventor: Birgit BRANDT, Sonneberg (DE)

(21) Appl. No.: 14/651,731

(22) PCT Filed: Dec. 11, 2013
(86) PCT No.: PCT/EP2013/076264

§ 371 Date: Jun. 12, 2015

(30) Foreign Application Priority Data
Dec. 12, 2012 (DE) 10 2012 112 186.9

(51) Int. Cl. H01M 4/66; H01M 4/88; H01G 11/86; C25B 11/02; H01G 11/26; H01M 4/04; H01M 4/139

(52) U.S. Cl. CPC H01M 4/66; H01M 4/043; H01M 4/0402; H01M 4/8817; H01M 4/8896; H01M 4/139; C25B 11/02; H01G 11/26; H01G 11/86

(57) ABSTRACT

A material composite includes a coating material having particles and a base material, wherein 1) the base material contains on its surface depressions which lead to a reduced thickness of the base material at the position of the depressions, 2) the depressions are deviations from a smooth plane surface of the base material, and 3) geometrical dimensions and/or shapes of the particles and the depressions are similar or match such that one or more particles fully or partially fit geometrically into the individual depressions or penetrate adheringly by a force and/or energy so firmly that the adhesion is at least partially based on mechanical forces between particles and base material.

### TECHNICAL FIELD

This disclosure relates to a material composite comprising coating material containing particles as well as a base material to be coated. The particles may be incorporated into a binder.

The disclosure also relates to a material composite for electrochemical systems, which may, for example, consist of an electrical lead and an electrode containing particles, to a method of its production and to its use in electrochemical systems and other coating systems. This disclosure further relates to electrochemical systems (batteries, fuel cells, electrolysis cells) and other systems containing the aforementioned material composite.

The disclosure furthermore relates to a material composite comprising coating material containing particles as well as a base material to be coated, in which case the base material may be selected from any materials such as metals, glass, wood, building materials or further inorganic or organic materials or biomaterials. Furthermore, such base materials may be provided with inorganic coats such as glass and with metal coatings. The disclosure also relates to methods for producing this material composite.

### BACKGROUND

The coating of all types of surfaces with materials containing particles is used in very many fields of daily life.

Of particular economic importance are electrochemical systems and processes which have increased enormously in importance in recent years. In particular, batteries such as lithium ion batteries have good opportunities for use in the mobile field, for example, to fully or partially store the energy of a tankful or to supply electricity in motor vehicles. Furthermore, such systems are also suitable for static energy applications, for example, temporary storage of excess regenerative energy, for example, wind and solar energy, or for backup electricity supply. In addition, use for electricity supply in mobile devices such as laptops may be envisioned. Moreover, no limits are placed on use, for example, in fuel cells, electrolysis processes or electrochemical processes.

Electrodes, i.e., anodes and cathodes, for such systems and processes are often porous and contain the following components and substances, see, for example, Streng, Birgit: Wasserstoffelektroden in technischen Elektrolyseprozessen unter Einsatz von Wolframcarbid als Elektrokatalysator [Hydrogen electrodes in technical electrolysis processes using tungsten carbide as an electrocatalyst], Dissertation, Technical University of Dresden, 1988.
(a) “Electrochemically active material,” referred to below as “active material,” on the surface of which there are electrochemically active centers where the electrochemical reaction takes place. At the start of the electrode production, the active material is in the particulate powdered state. A typical particle size may be 2 μm. Other particle sizes less or greater than 2 μm may also be envisioned, for example, 10 μm. Conceivable electrochemically active materials may, for example, be: lithium compounds, for example, lithium iron phosphate, lithium titanate, lithium niobate, platinum and platinum compounds, lead, lead oxide, lead sulfate, lead compounds, nickel, nickel oxide, nickel compounds, cadmium, cadmium oxide, cadmium compounds, silver, silver oxide, silver compounds and organic compounds, which may also be polymeric.
(b) A material containing carbon such as “carbon black” and/or “graphite” and/or “graphene” and/or carbon nanotubes, is used to receive the electrochemically active material and improve the electronic conductivity of the final electrode material. Carbon black and/or graphite are in the particulate powdered state at least at the start of the electrode production. A typical particle size for the carbon black components may be ≦100 nm. Graphite may be used with a particle size from 10 to 25 μm. The particle sizes for carbon black and graphite may, however, lie outside the aforementioned particle sizes.
(c) The “binder” which may, for example, consist of polytetrafluoroethylene or polyvinylidene fluoride, polyvinylidene fluoride-hexafluoropropylene (PVDF-HEP) or carboxymethyl cellulose or an alkali metal salt of carboxymethyl cellulose, for example, sodium carboxymethyl cellulose, potassium carboxy cellulose or lithium carboxy cellulose (DE 10 2010 008 782), as well as a liquid medium suitable therefor, which converts the binder into a liquid or gel state, leads to mechanical stabilization of the entire electrode material consisting of the material containing carbon such as carbon black and/or graphite, and active material. The binder therefore has an adhesive and mechanically stabilizing effect between the individual particles.
(d) Components a) and/or b) and c) may be mixed to form an “electrode mixture.”
(e) The generally planar “electrical lead,” which is used as a receiving material and to stabilize the mechanical cohesion of the electrode mixture may, for example, consist of aluminum foil as well as copper foil in lithium ion batteries. Electrical leads made of metal plate or mesh or fibrous materials may also be envisioned (DE 40 19 092). Electrical leads made of expanded metal have been described inter alia in WO 2004/053200 and DE 102 57 186. Furthermore, electrical leads consisting of or containing carbon, carbon fiber material, vitreous carbon, graphene, materials containing graphene, for example, plastics containing graphene or carbon-coated metal foils, in which case the metal may, for example, be aluminum, may also be used, for example, WO 2011/141 486. In lead-acid accumulators, according to the prior art lead mesh or mesh consisting of lead-antimony alloys may generally be used (see Handbuch für verschlossene Gel-Blei-Batterien [Handbook of closed gel lead-acid batteries]. Expanded metal is a material in the form of a mesh with openings in the surface, and is also known by the term expanded mesh.

Controlled treatment and/or structuring of the surface of coatings, in particular taking into account the mathematical, geometrical and mechanical action mechanisms between the surface and the particles of the coating, is not known either in electrical leads for electrochemical systems or in other coating systems.

The combination of the loose solid constituents containing, for example, crystals, molecules, atoms or aggregates of the same, referred to below as “particles” which may contain or consist of components a), b), c) and/or d), may form a “particle electrode” and be applied onto the “electrical lead” e). This creates a material composite consisting of the electrical lead and the particle electrode, also referred to below as “material composite.” The active material a) must necessarily be present in electrochemical systems since the electrochemical reactions take place on its surface. The use of a material (adhesion promoter) which improves the cohesion between the electrical lead and the particle electrode is mentioned inter alia in DE 100 30 571 and WO 2005 091396.

The precise composition, and in particular the nature, of the electrochemically active material of the electrodes varies according to the type of battery, the system, the process and the type of electrode (anode or cathode).

The electrodes (anode and cathode) produced in this way are subsequently assembled together with the electrolyte (optionally with the use of a separator to receive the electrolyte and for use as a spacer between the positive and negative electrodes) to form cells. The cells may be constructed from a plurality of such anode/electrolyte/cathode units.

The electrode discharge reactions are listed below with reference to the example of a known lithium ion battery:

### Negative Electrode:

The negative electrode is discharged according to the following reaction equation:

y Li (intercalated in graphite*)→y Li⁺+y e⁻+graphite

*) as LiCz, where z can reach a value of up to 6, see DE 100 30 571.

The graphite is fully or partially reduced during the discharge.

### Positive Electrode:

The discharge process at the positive electrode can be formulated as follows:

Li_{1-y}Mn₂O₄+y Li⁺+y e⁻→LiMn₂O₄.

The electrons liberated during the electrochemical reaction at discharge induce a flow of current and can therefore be used for the energy supply of an external unit, for example, a laptop, automobile, or static energy supply.

### Redox and Overall Equation (Discharge):

Li_{1-y}Mn₂O₄+y Li (intercalated in graphite*)→LiMn₂O₄+graphite.

During charging, the aforementioned reactions take place in the respective opposite direction.

Lithium manganate and lithium (intercalated, for example, in graphite) in this case respectively function as an active material (see point a) above).

The expression “and/or” used below covers any and all combinations of one or more elements mentioned.

In practice, there is a great demand for methods of producing reproducible electrochemical cells. This is because reproduction errors are often observed which can consist, for example, in local electrical contact resistances occurring because of the complex material composition of such electrochemical cells. Further causes are overvoltages or uncontrolled chemical and/or electrochemical reactions, for example, of water traces with the electrical lead and/or the active material, in particular corrosion reactions.

One important object in producing final electrodes, containing active material, for such systems is to connect the aforementioned components a), b) and c) or d) to the electrical lead e) to ensure very good mechanical adhesion and at the same time electrochemical function of the material composite, consisting of the electrical lead and the particle electrode, or of the electrochemical cell resulting therefrom.

In practice, in particular for lithium ion batteries, metal foil is often used as the electrical lead. Metal foil is furthermore generally more economical than expanded metal. One great problem, particularly when using metal foils, is flaking and detachment of the particles of the particle electrode, or of the active material, from the surface of the electrical lead, which also leads to an increase in the electrical contact resistance between the electrical lead and the electrochemically active material (see, for example, DE 10 2011 004 932, p. 2 [0006]). Further consequences are, for example, local heating which may in the extreme case cause burn-through of the battery, reduced charging capacity, energy losses. The aim of further developments is therefore to provide an intimately adhering material composite consisting of particle electrode and electrical lead, as well as a method suitable therefor which is as economical as possible.

EP 0599 603 describes an electrode for use in alkaline electrochemical cells, containing a substrate and an outer layer of an electrochemically active material, the substrate having a surface which is modified to create an irregular surface on the one hand by an interlayer, and on the other hand by roughening or sandblasting or electrochemical etching. EP 0599 603 does not, however, describe the precise geometrical dimensions and shapes which the base material surface and the particle surface must have so that good mechanical adhesion of the particles to one another and between the particles and the base material is achieved. In particular, EP 0599 603 does not describe that the particles (by virtue of the adapted geometrical shapes and dimensions of the particles to one another and between the particles and the base material) penetrate so firmly adheringly by the effect of force and/or energy into the base material, or the particles adhere so firmly to one another, that this adhesion is at least partially based on mechanical forces between particles and between the particles and the base material.

The problem of lack of adhesion of coatings containing particles on surfaces furthermore arises in many fields of coating technology, for example, painting of automobile components. The particles may in that case, for example, be inorganic or organic colorants.

### SUMMARY

I provide a material composite including a coating material having particles and a base material, wherein 1) the base material contains on its surface depressions which lead to a reduced thickness of the base material at the position of the depressions, 2) the depressions are deviations from a smooth plane surface of the base material, and 3) geometrical dimensions and/or shapes of the particles and the depressions are similar or match such that one or more particles fully or partially fit geometrically into the individual depressions or penetrate adheringly by a force and/or energy so firmly that the adhesion is at least partially based on mechanical forces between particles and base material.

I also provide an electrochemical system, battery, fuel cell, electrolysis cell or double-layer capacitor containing the material composite including a coating material having particles and a base material, wherein 1) the base material contains on its surface depressions which lead to a reduced thickness of the base material at the position of the depressions, 2) the depressions are deviations from a smooth plane surface of the base material, and 3) geometrical dimensions and/or shapes of the particles and the depressions are similar or match such that one or more particles fully or partially fit geometrically into the individual depressions or penetrate adheringly by a force and/or energy so firmly that the adhesion is at least partially based on mechanical forces between particles and base material.

I further provide a method of producing a material composite which includes a coating material containing particles and a base material including in chronological succession: A) determining spatial dimensions and size distribution of the particles, B) adapting and/or adjusting optimal particle size and shape wherein 1) the base material contains on its surface depressions which lead to a reduced thickness of the base material at the position of the depressions, 2) the depressions are deviations from a smooth plane surface of the base material, and 3) geometrical dimensions and/or shapes of the particles and the depressions are similar or match such that one or more particles fully or partially fit geometrically into the individual depressions or penetrate adheringly by a force and/or energy so firmly that the adhesion is at least partially based on mechanical forces between particles and base material, C) structuring the surface of the base material such that the particles of the particle electrode geometrically fit into the depressions of the surface of the base material, D) cleaning the base material with a compatible cleaning agent and/or solvent and/or by a physical method, E) drying the base material in a vacuum or in a protective gas atmosphere or in air and/or at elevated temperature, F) preparing the coating material by mixing electrochemically active material, material containing carbon, and binder, to form a homogeneous mixture, G) coating the base material structured according to step C) with the coating material containing particles adapted according to steps A) and B), the base material being at the same temperature or at a higher temperature in comparison to the coating material, H) drying the coated base material, and I) spatially compressing the layer produced according to step G or H, which may be at any temperature.

### BRIEF DESCRIPTION OF THE DRAWINGS

FIGS. 1(a) and 1(b) are schematic cross-sections of an electrical lead with depressions in polygonal and semi-elliptical shapes, respectively.

FIGS. 2(a) and 2(b) are schematic cross-sections of particles having triangular and elliptical shapes, respectively.

FIGS. 3(a), 3(b) and 3(c) are schematic cross-sections of general particles contained in or free from a depression in an electrical lead.

FIG. 4 shows a schematic cross-section of an electrical lead with general particles occupying depressions in its surface.

FIG. 5 shows a schematic cross-section of an electrical lead with a pore containing multiple particles.

FIG. 6 schematically shows particles being applied to an electrode lead strip with rolls.

FIG. 7 schematically shows a particle with gearwheel-shaped anchors.

FIG. 8 schematically shows particles attached to an electrical lead and each other.

FIG. 9 schematically shows particles with clip depressions attached to an electrical lead and each other.

### LIST OF REFERENCES

1 Electrical lead (for example, metal sheet or foil) or base material
2 Depression in the surface of the electrical lead, or of the base material
3 Polygonal particle
4 Elliptical particle
5 Particle, general
6 Particle, exclusively consisting of electrochemically active material
7 Feed device for particles or coating material, for example, loose material dosing device, material height-regulated over the entire width of the base material, optionally particle feed under pressure
8 Calender roller (compression of the particles with foil)
9 Base material—continuously moved in arrow direction (for example, lying on a conveyor belt and fixed by vacuum suckers)
10 Coating on base material
11 Particle with gearwheel-shaped bumps, anchors or hooks
12 Particle with clip depressions

### DETAILED DESCRIPTION

With reference to the example of an electrical lead/particle electrode as contained in electrochemical cells, on the one hand the structure and surface geometry of the electrical lead onto which the particle electrode is applied by any method, for example, spreading, pressing, brushing, spraying, calendering, is prepared and modified in a controlled way so that adhesion of the electrode particles on the surface of the electrical lead is improved as far as possible and contact resistances are thereby reduced as far as possible. In the simplest case, this may, for example, be done by mechanical roughening by sandpaper with a suitable grain size or by pointwise-accurate laser treatment. In the ideal case, the surface of the electrical lead and the coating particles match one another so well before, during and/or after the coating, or are so similar, that the contact area between the electrical lead and the particles reaches a maximum. In any event, the surface of the electrical lead must allow the particles of the particle electrode to be able to adapt in terms of their shape and dimensions to the surface of the electrical lead.

On the other hand, the surface geometry of the particles of the particle electrode may additionally be adapted to the surface structure of the electrical lead. Modification of the particle geometry is possible, for example, by mechanical grinding, screening and/or deliberate control during the production of the particles, for example, by selection of suitable chemical precipitation conditions.

Penetration of the particles into the depressions of the surface of the electrical lead may, according to a particular example, be achieved such that the particles fully or partially penetrate into the depressions after the coating step by the effect of force and/or energy, the particles preferably being harder than the base material or the electrical lead. This may, for example, be done by pressing and/or calendering. In calendering, a line pressure of preferably from 0.01 to 1500 N/mm is set, more preferably from 0.01 to 700 N/mm, even more preferably from 200 to 500 N/mm. The application pressure is preferably from 0 to 100 MPa, even more preferably from 10 to 32 MPa. The action time during the pressing or calendering is preferably from 0.01 to 10.0 minutes, preferably from 0.5 to 3 minutes.

The aforementioned effect of the improved adhesion is achieved by the diameters of the predominantly occurring particles being selected to be smaller than the diameters of the predominantly occurring depressions on the surface of the electrical lead so that one or more particles, in the ideal case the predominant fraction of the particles, for example, 90% of the number of the particles, fit geometrically into the most frequently occurring depressions on the surface of the electrical lead so that there is a contact area as large as possible between the electrical lead and the particles. Depressions on the surface of the electrical lead or the base material are to be understood as deviations from a smooth plane surface of the base material, which locally leads to a reduced thickness of the base material at the depressions. Owing to the geometrical match of the particles and the base material, there is a substantially force-fit or formfit connection between the electrical lead and the particles of the particle electrode, as well as a material composite resulting therefrom. The particles of the particle electrode adhere to the surface of the electrical lead essentially because of mechanical forces, for example, adhesion forces, clamping forces, binding forces—comparable to the purely mechanical macroscopic clamping of two components, for example, a nail in a depression or a mechanical clamping connection. This applies to the micro and nano ranges. As a result, the effect of significantly improved adhesion of the particles on the base material is achieved. Removal of the particles from the surface of the electrical lead (because of the aforementioned forces acting) is made difficult, or possible only by the effect of mechanical, thermal, electrical forces or corresponding energy and/or by the effect of any other chemical, physical and/or chemical/physical force and/or energy. Therefore, the particles of the particle electrode, at least directly on the electrical lead/particle interface or on the first layer of the particles on the electrical lead surface (because of the aforedescribed geometrical matching of the surfaces of the electrical lead and the particles) cannot be removed from the surface of the electrical lead by themselves, or not merely by the force of gravity. Furthermore, this improved adhesion between the particles and the electrical lead is advantageous when the resulting electrode and cells are to be curved or wound to produce cylindrical batteries instead of flat batteries.

Structuring of the electrical lead, however, also has limits. Thus, structures such as corners and edges protruding from the surface of the electrical lead must not be so high, or must not penetrate so far into the electrode, that during subsequent assembly of the cells the electrical lead of an electrode touches the separator or the electrical lead of the oppositely charged electrode. In that case, there would be a risk of a short circuit. The electrical lead with active material or with the particles of the particle electrode must therefore be so thick and covered so thickly, or the separator must be adapted to be so wide, that any risk of a short circuit is excluded.

Thus, the surfaces of the electrical lead and the particles are deliberately structured such that the nanostructure of the base material and the geometry of the particles of the particle electrode and the surface of the electrical lead are adapted to one another so that the diameter of the particles is selected to be at least as much smaller than the diameter of the depressions on the surface of the electrical lead so that particles and depressions on the surface of the electrical lead are connected and engaged with one another mechanically firmly and touching one another.

Preferably, the surfaces of the electrical lead and the particles are adapted to one another in the nano range, i.e., in the range of very small dimensions <1 mm. Ideally, the diameter of the depressions and of the particles is <=100 to 500 μm, preferably <=20 to 50 μm so that the contact area between the electrical lead and the particles is significantly increased over the prior art.

The contact area resulting in this way between the electrical lead and the particles is therefore substantially larger than the area calculated over the surface dimensions of an electrical lead. Because of the larger contact area, at the same time, a higher acting force, for example, adhesion force, is induced between the electrical lead and the particle electrode. The mechanical stability of such a material composite is significantly greater compared to the prior art, for example, a smooth electrical lead and particle sizes and shapes not geometrically adapted to the electrical lead.

The effect achieved by the firmly engaged connection, based on mechanical principles, between the electrical lead and the particle electrode is that electrical contact resistances between the electrical lead e) and the other components a), b) and c) or d), and the undesired heating resulting therefrom, are reduced. The electric current can therefore flow substantially unimpeded between the electrochemical active centers, where the electrochemical reaction locally takes place and which are located on the active material at the electrode surface, and the electrical lead. Any contact resistances hinder the electronic flow of current, and lead to undesired local heating and therefore energy losses. The less the electric current is impeded by the contact resistances, the better is the function and reliability of the overall system, or the overall process.

Another advantage is that (with sufficient mechanical meshing) the particles mechanically adhere so well in the depressions of the surface of the electrical lead that no binder is necessary at the electrical lead/electrode material interface. Since the binder generally has no electronic conductivity, or only low electronic conductivity, the binder impairs electronic conductivity of the overall particle electrode. Besides the advantage of saving on material, partial or full avoidance of binder therefore also has an advantageous effect on the improved electronic conductivity of the material composite consisting of the electrical lead and the particle electrode. Because of this, in turn, local heating due to contact resistances is reduced.

In particular, metal foil made of aluminum is on the one hand economical. On the other hand, metal foil can be coated in a continuous coating method. The usually smooth surface of the metal surface, however, leads to less adhesion, or adhesion insufficient for continuous operation, of the particle electrode on the metal foil, which results in higher contact resistances and ultimately energy losses. Usually, in such a case those skilled in the art opt for a mesh-shaped electrical lead to improve adhesion of the electrode particles from the mesh-shaped electrical lead (see EP 2287945). Mesh-shaped electrical leads are, however, generally more expensive than electrical leads in the form of sheet metal or foil. Furthermore, it is easier in terms of design and production technology to connect an electrical lead in the form of sheet metal or foil to the external circuit, for example, an incandescent lamp consuming current, compared to a mesh-shaped electrical lead. In mesh-shaped electrical leads, the connection to the external circuit must be carried out by additional mechanical or material-fit electrical connection. In electrical leads in the form of sheet metal or foil, during their manufacture a lug of the relevant sheet metal or of the relevant foil may be fed into the space outside the cell for the purpose of electrical connection so that contact resistances are restricted or avoided and so that the foil or sheet metal then respectively consist of one piece.

Preferably, because of their dimensions and three-dimensional mathematical shape, the particles should fit exactly or almost exactly into the surface structure, particularly into the depressions on the surface of the electrical lead so that the connection of the particles and the electrical lead forms a firmly adhering mechanical connection.

The term “almost exactly” (as mentioned above) is to be understood by way of example that the most frequently occurring diameter of the particles is respectively at least 50% or at least 30% or preferably at least 20% or particularly preferably at least 10% or even more preferably at least 1% or 5% smaller than the most frequently occurring diameter of the depressions on the surface of the electrical lead.

Adhesion as explained above, based on mechanical principles, between the electrical lead and the particles of the particle electrode may be combined with or assisted by chemical, electrochemical and/or other chemical and/or chemical/physical methods and mechanisms to improve the adhesion between the electrical lead and the particle electrode.

By way of example, the use of one or more adhesion promoters according to DE 10 2006 06407, DE 10 2004 014 383, WO 2006 013 044, WO 002005 091 396 may be mentioned, which are applied onto the electrical lead before the electrical lead is coated with the particles of the particle electrode to improve adhesion between the particles and the electrical lead. However, the adhesion promoter may also be carried out after the coating, for example, by spraying a suitable solution of the adhesion promoter onto the electrical lead coated with particles, even if the surface structures of the particles and the electrical lead are not adapted to one another.

Suitable adhesion promoters may, for example, be:

For example, an epoxy resin which contains an optimal proportion of conductive carbon, determined beforehand by routine tests. This is aimed at a sufficient electrical conductivity together with a sufficient bonding effect.

All other known binders which are essentially organic in nature, for example, PVDF, PTFE, PE, PP, dispersed or in combination with their solvent.

The adhesion promoter may also be an alkali metal salt of carboxymethyl cellulose, and may contain electrically conductive additives such as carbons or graphite. A lithium salt of carboxymethyl cellulose is preferably used.

Furthermore, preferably, the adhesion promoter may contain or consist of a plant oil, for example, linseed oil, i.e., oil obtained from the flax plant, or heat-treated linseed oil or a dilution of linseed oil, in which case solvents such as turpentine or ethanol may be used. Addition of linseed oil leads to a strong bonding effect between the particles. A composite of particles and linseed oil obtained in this way is particularly elastic. Entirely independently of the geometrical surface structure of the particles of the particle electrode and the surface of the electrical lead, electrochemical cells may also contain adhesion promoters containing plant oil in particular to improve the mechanical stability of the particle electrode or the connection between the electrical lead and the particle electrode.

The electrical lead is a planar or surface-active material and it may, for example, consist of metal foil, sheet metal, perforated sheet metal, expanded metal, metal mesh or metal foam.

The electrical lead may contain or consist of metal such as copper, aluminum, nickel, lead, steel, stainless steel, titanium, tungsten, zirconium, tantalum, zinc, palladium, gold, chromium, cobalt, vanadium, noble metal-coated titanium or tantalum, in which case the noble metal may, for example, be platinum, ruthenium or a platinum-iridium alloy, and/or carbon. This also includes carbon fiber material, graphite film, vitreous carbon. That is to say (depending on the application) it is also possible to use any alloys of the aforementioned metals with one or more further elements of the periodic table as an electrical lead. Furthermore, the electrical lead may also be a coated material which contains the aforementioned metals in its coating, the coating touching the electrode material inside the electrochemical cell. Preferably, for example, in lithium ion batteries, a fold-free and/or ideally never previously folded metal foil, for example, consisting of respectively smooth, planar aluminum and/or copper, is used. This foil is subsequently provided with the depressions. Depressions on the surface of the electrical lead are not exclusively to be understood as continuous holes and perforations deliberately introduced beforehand into the electrical lead material, as in the case of expanded metal and meshes. Depressions are exclusively deviations from a smooth, plane surface of the electrical lead in the region of the part of the electrical lead coated with particles of the particle electrode, which lead to a reduced thickness of the electrical lead material locally at the relevant “deviating” positions. This specifically means that a metal mesh, perforated sheet metal or expanded metal, the mesh or webs of which themselves have a smooth surface, may be provided with depressions deliberately introduced beforehand on the mesh surface or expanded metal surface. The procedure for use and modification of the surface structure of a mesh or expanded metal is the same as described above for metal foil or sheet metal.

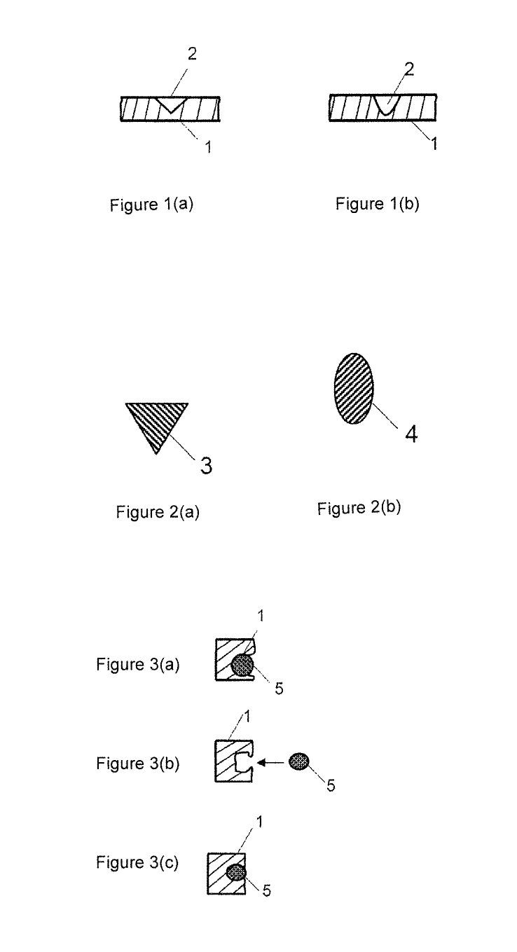

Depressions in the surface of the electrical lead or of the base material may in this case have the following shapes:
spherical or hemispherical
elliptical or semi-elliptical
triangular, quadrilateral, pentagonal, hexagonal to n-gonal, where n may be any natural number and the mathematical dimensions between the individual vertices in the depression may be either the same and/or different to one another and/or may be connected to one another by any mathematical function. Possible exemplary depressions in the surface of the electrical lead are represented in FIG. 1 (FIG. 1(a): polygonal depression; FIG. 1(b): semi-elliptical depression).
Formation of a clip structure between the particles of the particle electrode and the depressions in the surface of the electrical lead, which is characterized in that the inner diameter d2 in the near-surface region of at least one depression is smaller than the diameter d1 in the region remote from the surface inside the respective pore so that after one or more particles have penetrated into this pore the removal of the same particle(s) from this pore is mechanically made difficult or prevented because of the clip structure or because of the reduced pore diameter at the near-surface pore edges. (FIG. 5) The terms near-surface and remote from the surface in this case refer to the mathematical distance from the surface, measured, for example, in nanometers, micrometers, millimeters.

Besides the spatial dimensions of the particles and the surface of the electrical lead, their actual respective geometrical shapes are crucial for, on the one hand, a connection as mechanically strong as possible to be formed between the particles of the particle electrode and the surface of the electrical lead. On the other hand, the electrical contact resistance is reduced when the contact area between the particles and the surface of the electrical lead increases and/or the adhesion force between the particles of the particle electrode and the surface of the electrical lead increases.

The particles of the particle electrode may have the following shapes:
spherical or hemispherical
elliptical or semi-elliptical (see FIG. 2(b), particle 4)
triangular (see FIG. 2(a), particle 3), quadrilateral, pentagonal, hexagonal to n-gonal, where n may be any natural number >=4 and the mathematical dimensions between the individual vertices and edges on the surface of the particle may be either the same and/or different to one another and/or may be connected to one another by any mathematical function. Examples of n-gonal particles may be pyramids, prisms, tetrahedra, cones, octahedra, dodecahedra or star-shaped particles. Exemplary particles are represented in FIG. 2.
The aforementioned shapes, i.e., for example, spherical, elliptical particles, polyhedral bodies, octahedral bodies, star-shaped structures, on the surfaces of which there may respectively be firmly connected or firmly anchored rounded or angled bumps, hooks, anchors, spherical structures or any n-gonal structures, where n may be any natural number >=4 and the mathematical dimensions between the individual vertices and edges on the surface of the particle may be either the same and/or different to one another and/or may be connected to one another by any mathematical function. Examples which may be mentioned are the shape of a sphere or an octahedron, from the surface of which regularly or irregularly distributed cones protrude to form a star shape. In principle, all morphologies which occur in crystals are possible in this case.

One or more particles of the particle electrode may respectively be introduced into a single depression on the surface of the electrical lead.

According to a particular example, the geometrical shapes of the particles of the particle electrode and the depressions in the surface of the electrical lead are similar and matched to. That is to say, for example, round depressions in the surface of the electrical lead connect to round particles of the particle electrode, octahedral depressions in the surface of the electrical lead connect to octahedral particles of the particle electrode, elliptical particles of the particle electrode connect to identically elliptically shaped depressions in the surface of the electrical lead or the like. The aforementioned geometrical surfaces are produced by respectively adapted chemical, chemical/physical and/or physical methods. For example, octagonal depressions in the surface of the electrical lead may be produced by mechanical treatment using octagonal sand grains under the effect of a defined mechanical force.

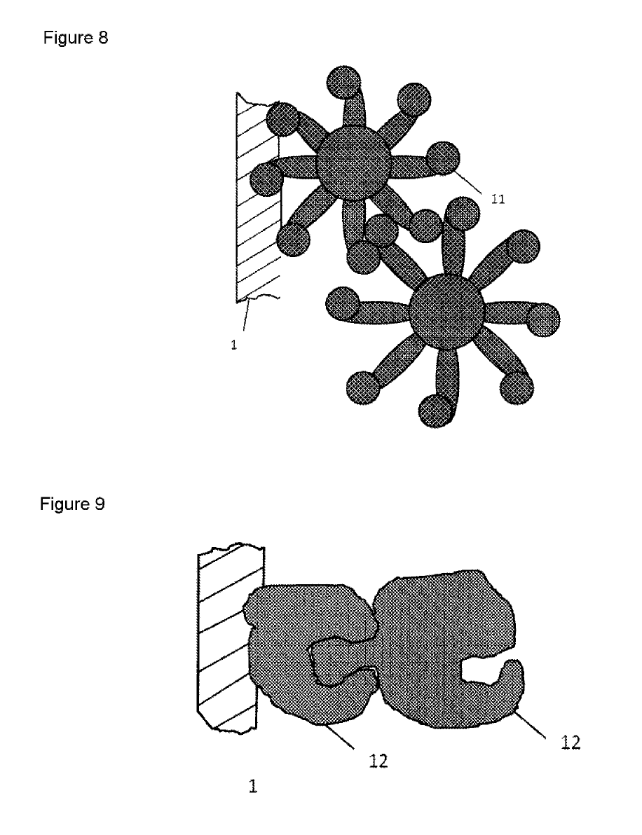

Special structures may protrude from the spherical, elliptical or n-gonal surface of the particles (distributed regularly or irregularly over this surface) which structures may be part of these particles or firmly connected to these particles. Such structures may, for example, be cones so that overall star-shaped particles are formed, or bumps or anchors, which are ideally gearwheel-shaped and/or provided with hooks. FIG. 7 shows a particle by way of example the cross section of a sphere, from the surface of which regularly or irregularly distributed gearwheel-shaped hooks, bumps or any other bodies may protrude. Instead of a sphere, the particles may also contain any polyhedra, for example, cubes, tetrahedra, icosahedra, octahedra, dodecahedra, from the surface of which regularly or irregularly distributed gearwheel-shaped hooks, bumps, anchors or any other bodies protrude. The surface of the base material is characterized by the aforementioned clip structure as represented in FIG. 5, or contains at least depressions according to FIGS. 1 and/or 4. By special bumps, anchors or hooks, which protrude from the particle surface and which are parts of the particles themselves, on the one hand the particles can be hooked, connected or engaged firmly with the base material so that the particles cannot be separated again, or can be separated again only by the application of additional forces on the base material. Furthermore, the particles may also be firmly engaged, connected or clamped with one another (as represented by way of example in FIGS. 8 and 9) or form a firm composite of particles so that good mechanical adhesion is achieved between the particles themselves and so that the particles cannot be separated from one another, or can be separated from one another only by application of additional forces. In this way, on the one hand the mechanical adhesion between the particles and in the composite with the base material is improved, and on the other hand the electrical contact resistances between the particles and in the composite with the base material are reduced.

Furthermore, the particles may have depressions containing a clip structure on their surface itself (as represented in FIG. 5 for the base material so that the particles can be firmly connected, clamped or engaged with one another (see FIG. 9). Such depressions containing clip structures are characterized in that the inner diameter d2 in the near-surface region of the particle of at least one depression is smaller than the diameter d1 in the region remote from the surface inside the respective pore so that after one or more particles have penetrated into this pore the removal of the same particle(s) from this pore is mechanically made difficult or prevented because of the clip structure or because of the reduced pore diameter at the near-surface pore edges. The terms near-surface and remote from the surface in this case refer to the mathematical distance from the surface, measured, for example, in nanometers, micrometers, millimeters.

In the material composite the geometrical shapes and the mathematical dimensions of the particles of the particle electrode and of the depressions in the surface of the electrical lead may be similar such that at least 99.99% or at least 80% or at least 50% or at least 20% or at least 10% of the surface of the electrical lead is touched by the surface of the particles of the particle electrode. Ideally, respectively at least 10%, preferably 20%, more preferably 50%, of the surface of the particles is fully touched by the surface of the electrical lead.

Material composites formed from particles and the surface of the electrical lead as a function of their surface geometry are represented by way of example in FIGS. 3(a)-3(c).

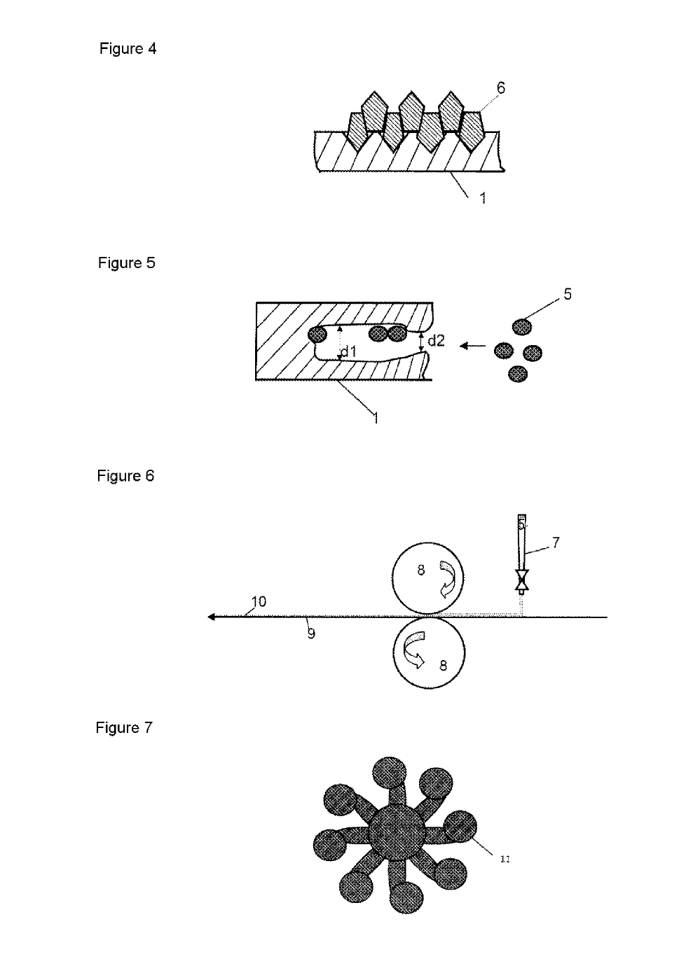

According to a particular example and using the above-explained principles of adaptation of geometrical shapes and dimensions of the surfaces of the particles and the electrical lead, the surface of the electrical lead is provided or coated exclusively with particles consisting of electrochemically active material. (FIG. 4) This coating may be so thin, or minimal, that the layer of the active material comprises only from one to three or a few atomic layers.

Another criterion for good mechanical adhesion between the particles of the particle electrode and the surface of the electrical lead, and an electrical resistance which is as low as possible between the particles of the particle electrode and the surface of the electrical lead, is the mechanical force acting, for example, the adhesion force between the particles and the surface of the electrical lead. This force is dependent inter alia on that energy which is exerted when applying the particles of the particle electrode onto the surface of the electrical lead.

By the procedure explained above, it is possible to accurately adjust the number of atomic layers exactly or approximately in relation to the coating material on the surface of the electrical lead.

Furthermore, the material composite described above is also suitable for production of electrodes and their use in batteries other than lithium ion batteries. Such electrodes may then be used in the electrochemical cell as a positive and/or negative electrode, or as a cathode or anode. Examples of such batteries are lead-acid accumulators, lithium-air batteries, lithium-sulfur batteries, zinc-air batteries, nickel-cadmium accumulators, zinc-carbon batteries, nickel-metal hydride batteries, alkaline-manganese batteries and the like. These may be primary or secondary elements. Such batteries may, for example, and depending on the battery type, be used in laptops, small electrical devices, vehicles or for static energy storage and supply.

The material composite is furthermore suitable for production of electrodes for further electrical systems, in particular double-layer capacitors.

The material composite may (depending on the material composition and structure) be used as a positive or negative electrode connected to the electrical lead in further electrochemical cells such as fuel cells, electrolysis cells, in electrochemical measuring cells or in all other electrochemical cells. Usually, electrochemical cells are assembled by combining a negative and positive electrode and an electrolyte introduced between the electrodes and (if necessary in the individual case) separators or membranes, optionally to receive a liquid or solid electrolyte.

The aforementioned principle of coating an electrical lead, which may also be referred to as a “base material,” with electrode material for the purpose of electrochemical cell application may be applied or generalized to all coating processes and material composites resulting therefrom, by adapting the particles contained in the coating material optimally in terms of size and shape (as already described above for the electrical lead/particle electrode case, to a structured surface of the base material and/or by structuring the surface of the base material such that the particles of the coating material can penetrate into the depressions on the surface of the base material and adhere mechanically firmly on the surface of the base material. The substantially higher forces resulting therefrom between the coating and the base material lead to significantly improved adhesion of the coating on the base material and lower susceptibility to flaking of the coating. Exemplary applications of such coatings are all types of paint and plastic coatings, for example, on automobile parts, coatings in the building industry, in photovoltaics, including all inorganic coatings and the like.

The coating method that produces such a material composite, for example, for cathodes or electrodes in lithium ion batteries, may contain the following Steps 1-12: 1. Determining the spatial dimensions of the particles and the size distribution of the particles intended for the coating by a suitable measuring technique. Such methods of determining the particle size and particle size distribution are known, for example, laser scanning microscopy or static laser scattering. If such determination of the particle size distribution is not 100% accurately possible, then an approximate determination of the average particle size most frequently occurring should be carried out. If the particle size distribution is known, this Step 1, or the determination of the particle size distribution, may even be omitted during the coating method.

Optionally, instead of or in addition to Step 1: adapting/adjusting the particle size and shape, for example, by mechanical grinding, sifting methods, screening, by selection of the synthesis processes and parameters, in particular taking into account physical and chemical parameters such as temperature, pressure, chemical composition, under the influence of magnetic and electric fields, for example, during chemical precipitation of the particles in a solution, by controlled crystallization, which may respectively be determined by routine methods. For example, or for comparison, the formation of complex, inter alia star-shaped snow crystals may be mentioned, as explained, for example, in JOHN W. BARRETT, HARALD GARCKE, ROBERT NURNBERG, Phys. Rev. E 86 (2012) 011604 or in G. L. KIEL: Anorganisches Grundpraktikum kompakt: Qualitative and quantitative Analyse [Concise basic inorganic practice: Qualitative and quantitative analysis], WILEY-VCH, 2012, p. 93 ff. Also to be considered is biotechnological production of specially shaped crystals, for example, genetically controlled, as discussed in C. SOELLNER, E. BUSCH-NENTWICH, T. NICOLSON, J. BERGER AND H. SCHWARZ, Control of Crystal Size and Lattice Formation by Starmaker in Otolith Biomineralization, Science, 10 Oct. 2003. To achieve the respectively desired shape, formation of the particle shape may, for example, be monitored by laser scanning microscopy or scanning electron microscopy. The particles may also be produced by micro- or nanomilling, i.e., the particle surface is adjusted by mechanical abrasion. Particles may furthermore be deliberately shaped, and their dimensions adjusted, by three-dimensional printing methods in the micro and nano ranges, optionally computer-controlled. In this way, tailored production of specially shaped particles such as the aforementioned wheel or star shapes can be achieved. Polyhedral particles may be produced, for example, octahedra, which preferably grow further on the vertices and edges of the particles so that, for example, star-shaped particles result. Further methods of producing the complex particles with a defined structure are three-dimensional printing methods, inter alia 3D laser lithography, see, for example, Sensormagazin [Sensor Magazine] February 2013, p. 36/37 and Zeitschrift Mikroproduktion [Journal of Microproduction] March 2013. The particle size and shape should in this case ideally be defined and adjusted beforehand so that the particles are engaged, clamped and connected as firmly as possible in the depressions of the base material or with the base material. On the other hand, the particle shape and size should be adjusted and dimensioned so that the particles are mechanically clamped and connected to one another in a similar way to gearwheels (see FIG. 7) or by hooks which protrude from a spherical, elliptical or polyhedral surface.

Adjustment of the optimal particle size and shape may be carried out such that in the resulting material composite the geometrical shapes and the mathematical dimensions of the particles of the particle electrode and of the depressions in the surface of the electrical lead are similar such that at least 99.99% or at least 80% or at least 50% or at least 20% or at least 10% of the surface of the electrical lead is touched by the surface of the particles of the particle electrode.

Advantageously, the particles of the particle electrode may be configured such that the above-explained clip structure according to FIG. 5 results.

2. Structuring the surface of the electrical lead or of the base material: the electrical lead or the base material may, for example, be a metal foil or an expanded metal consisting of aluminum, which in the initial state (except for the edges) has a smooth surface that merely has manufacturing-related irregularities of random nature. The controlled surface structuring is carried out such that those particles of the particle electrode, or of the coating material, whose size and most frequent distribution were determined according to Step 1 and/or adjusted according to Step 2 fit mathematically, or in terms of the spatial dimensions, as exactly as possible into the depressions of the surface. At least, the dimensions of the most frequently occurring particle sizes of the coating material should be smaller than the dimensions of the depressions in the surface of the electrical lead, or of the base material. According to one particular example, the most frequent diameter of the particles is respectively at least 50% or at least 30% or preferably at least 20% or particularly preferably at least 10% or even more preferably at least 1% or 5% smaller than the most frequently occurring diameter of the depressions on the surface of the electrical lead, or of the base material.

The surface structuring of the electrical lead or of the base material may be carried out such that, in the resulting material composite, the geometrical shapes and the mathematical dimensions of the particles of the particle electrode and of the depressions in the surface of the electrical lead, or of the base material, are similar such that at least 99.99% or at least 80% or at least 50% or at least 20% or at least 10% of the surface of the electrical lead, or of the base material, is touched by the surface of the particles of the particle electrode, or of the coating material.

Advantageously, the depressions or pores on the surface of the electrical lead, or of the base material, may be configured such that a clip structure according to FIG. 5 is formed.

The following may, for example, be methods for controlled structuring of the surface of the electrical lead, or of the base material, to be fully or partially coated:
Mechanical roughening or processing of the surface by mechanical methods such as sandblasting, roughening with sandpaper or other methods of mechanical surface modification, the grain size of the means for structuring the surface being established beforehand in a controlled way so that the depressions to be obtained in the surface of the electrical lead have defined geometrical dimensions and/or shapes as explained above.
Perforation or surface structuring of the base material by a laser or other suitable physical beams, preferably high-energy beams, by ultrashort pulsed laser treatment (see inter alia DE 197 44 368, Elektronikpraxis [Practical Electronics] 5.12.2013, STEFAN NOLTE et al.; Physik Journal [Journal of Physics] 5.12.2013, Deutscher Zukunftspreis 2013 des Bundespräsidenten [German Future Prize 2013 of the Federal President]; DR. DAVID OFFENBERG, DR. RAMONA LANGNER, JURGEN KOHLHOFF, STEFAN RESCHKE, Ultrakurzpulslaser zur Materialbearbeitung [Ultrashort pulsed lasers for material processing], 19.11.2012, Article of 13.11.2013, Produktion [Production], verlag moderne industrie GmbH, Justus-von-Liebig-Straβe 1, 86899 Landsberg.
Electrochemical and electrolytic methods of surface treatment and structuring, for example, as described in Carsten Kontje, Dissertation, University of Ulm, 2011, in particular anodizing, cathodizing, also known by the term electrochemical erosion. The surface, or the base material, to be structured is, for example, connected to a DC source by known methods. The plus and minus poles of the DC source are respectively electrically connected to the surface to be structured and a suitable back electrode. In metals, the metal to be structured is generally connected to the plus pole of the DC source and receives a sufficiently positive potential relative to the standard hydrogen electrode. Sufficiently positive means that the received potential must be so positive, or so high in magnitude, as to overcome all thermodynamic and kinetic barriers under actual conditions so that metal dissolving can take place. The surface to be structured and the back electrode are immersed in a suitable electrolyte solution, for example, dilute sodium nitrate solution.
Chemical methods with the suitable chemical etchant for the respective material (for example, dilute sodium hydroxide or dilute nitric acid for aluminum foil). However, the risk arises that uncontrolled, in particular uncontrolledly deep, depressions may be formed in the electrical lead.
Photolithographic structuring, carbon dioxide snow technique, electron beam lithography and other methods which are known from semiconductor structuring or microsystem technology.
Known methods of producing open-pored metal foams such as hot pressing or extrusion, powder metallurgical compression, gas injection into the melt, lasers sintering.
Impregnation calendering, in particular according to Kunststoffmagazin [Plastics Magazine], August 2010, p. 41.
Three-dimensional printing methods, inter alia 3D laser lithography, see Sensormagazin [Sensor Magazine] February 2013 p. 36/37 and Zeitschrift Mikroproduktion [Journal of Microproduction] March 2013.
Micro- or nanomilling, for example, mechanical or electromechanical, see inter alia Physikalische Blätter [Physics Letters] Volume 56, Issue 9, DOI: 10.1002/phb1.20000560904, Article first published online: 20 Feb. 2013, WILEY-VCH Verlag GmbH & Co. KGaA, Weinheim, Minat 2008, Elektrochemisches Fräsen halt Einzug in die Fertigung [Electrochemical milling makes its appearance in manufacturing], 8.10.2008.
   3. Degreasing and/or cleaning the electrical lead or the base material with distilled water and/or ethanol and/or acetone and/or another suitable solvent and/or cleaning agent. Cleaning agents and/or solvents are also intended to mean the media or agents mentioned below: vacuum, suction and/or compressed air to remove dirt particles from the surface of the electrical lead or of the base material; gases, which may also be pressurized and which can pick up and remove foreign substances when passing over the surface of the electrical lead or of the base material. Physical methods may, for example, be understood as vacuum, suction and/or compressed air.
   4. Additionally/as required: treatment with one or more chemical media and/or by chemical/physical and/or physical methods to remove electrically not very conductive oxide and/or hydroxide cover layers (for example, pickling) and/or for controlled production of electrically conductive cover layers on the surface of the electrical lead or of the base material. This type of treatment is used in particular when the material composite to be produced is an electrical or electrochemical system. Any oxides/hydroxides on the surface of the base material lead to contact resistances, which hinder the flow of current and are therefore undesirable. Preferably, in this case, the subsequent steps may be carried out in the absence of oxygen and water to avoid formation of new oxide layers, for example, in aluminum.
   5. If necessary: drying the electrical lead or the base material (according to requirements) in a protective gas, in air or preferably in a vacuum and/or at elevated temperature, it being advantageous to avoid air or oxygen or formation of electrically insulating oxide layers at the interface of the electrical lead with the electrode material.
   6. In addition, the electrical lead or the base material, for example, the aluminum foil may be coated with a chemically inert/highly corrosion-resistant, highly electrically conductive material (adhesion promoter as described above), before the particles of the particle electrode are applied onto the electrical lead coated in this way, or the base material.
   7. Preparing the particles of the particle electrode, or of the coating material by mixing the components according to a) to c) to form a homogeneous mixture. If necessary, the mixture produced in this way may be ground, for example, to adjust the desired particle size. Various methods may in turn be used to mix the electrode constituents or the coating constituents a) to c). The solid electrode constituents are preferably initially premixed dry until homogeneity of the mixture, and then mixed first with as little solvent as possible (for example, distilled water) and intimately stirred. Distilled water is then added gradually and stirring or mixing is again carried out intimately until homogeneity of the mixture. The binder, in particular a binder containing carboxymethyl cellulose, is swollen over a period of 1 to 24 hours in distilled water and again mixed to homogeneity after swelling. The swollen binder is generally added to the mixture at the end of the mixing process, and the mixture is again stirred or mixed to homogeneity. The binder may also be an alkali metal salt of carboxymethyl cellulose, preferably a lithium salt thereof. The effect achieved by using lithium carboxymethyl cellulose, for example, compared to sodium carboxymethyl cellulose, is that the lithium ions undertake the ionic conductivity in the carboxymethyl cellulose, while sodium ions do not. Sodium ions have a much larger ionic radius than lithium ions and can, for example, enter the electrolyte as a result of migration or ion movement in an electric field. This may cause undesired modifications of the electrolyte, for example, embrittlement of a solid electrolyte because the sodium ions occupy a larger volume. Furthermore preferably, the binder may contain a plant oil, for example, linseed oil, i.e., oil produced from the flax plant, or heat-treated linseed oil or a dilution of linseed oil, in which case solvents such as turpentine or ethanol may be used. Addition of plant or linseed oil leads to a strong bonding effect between the particles, or between the particles and the electrical lead. A composite of particles, or particles and electrical lead, respectively with linseed oil, obtained in this way is particularly elastic and therefore particularly suitable in producing wound or curved electrochemical or electrical cells. Entirely independently of the geometrical surface structure of the particles of the particle electrode and the surface of the electrical lead, the aforementioned electrochemical or electrical cells may also contain binders containing plant oil and/or containing alkali metal carboxymethyl cellulose, in particular lithium carboxymethyl cellulose, particularly to improve the mechanical stability of the particle electrode or the connection between the electrical lead and the particle electrode.
   8. According to a particular example, the surface of the electrical lead, or of the base material, is first treated according to Steps 2 to 7 or at least one of steps 2 to 7 and then coated with a mixture containing carbon, which may contain carbon black and/or graphite. This mixture containing carbon may additionally contain the binder. In this way, a kind of bridge which promotes electrical conductivity is initially formed on the surface of the electrical lead, or of the base material. Such a mixture containing carbon may also be a carbon thin film, as described in DE 10 2012 104 489. The electrode prepared in this way is then coated with electrochemically active material or electrochemically active material containing binder. The electrode produced in this way may subsequently be compressed, for example, by mechanical pressing or calendering.
   9. According to another example, the surface of the electrical lead is coated exclusively with active material.
   10. Coating the surface structured according to Step 2 with the coating material according to Step 1. The coating may be carried out according to respectively different known methods. Such methods are, for example, spreading, screen printing, mechanical pressing under pressure or suction in a vacuum, infiltration, electrophoresis, application, for example, electrostatically or under positive pressure (i.e., >atmospheric pressure) or reduced pressure (<atmospheric pressure)/spraying the dried powder, chemical vapor deposition (CVD), physical vapor deposition (PVD) or sputtering, as well as any chemical, chemical/physical and/or physical methods. The base material or the electrical lead may be at a higher temperature than the coating material, or heated, for example, to a temperature of up to 100° C. and the coating material may be at normal temperature. This treatment leads to the base material contracting during cooling so that the particles are clamped optimally into the depressions of the surface of the electrical lead.
   11. Drying the coated electrodes, or the coated material, at room temperature or elevated temperature, for example, by electrical contact drying, vacuum drying, in a protective atmosphere (for example, argon, nitrogen), air drying, IR, UV or another liquid-extracting radiation and/or by another known drying method. Controlling the drying temperature is carried out on the one hand with a view to heating which is as gentle as possible to evaporate the solvent so slowly that the particle composite inside the electrode compound or the coating material is not disrupted or perforated, and electronic contact resistances are avoided. On the other hand (for economic reasons) the drying process must also be carried out within a period of time as short as possible. Such controlling may be carried out by those skilled and is known. In each case, for example, in batteries containing lithium, water traces must be fully removed from the coating material to avoid chemical and/or electrochemical reactions of these water components with the active material and/or the electrical lead, and thereby induced electrical contact resistances and overvoltages and corrosion processes. Depending on the type of the preceding coating according to Step 10, the drying may also be omitted if the layer no longer contains any solvent.
   12. Optionally, spatial compression of the layer produced according to Steps 9-11 may be carried out, for example, by mechanical pressing or calendering at room temperature. The temperature during this compression process may be set in any desired way, preferably from 0 to 200° C., more preferably at room temperature. By this mechanical compression, the electrical contact resistance between the electrical lead and the particles of the electrode material, and between the particles of the electrode material, is further reduced.

Some of the method Steps 1-12 in the aforementioned method may, according to requirements for the coating, be fully or partially omitted, or known method steps may be added at any point.

As an alternative, and according to a particular example, Steps 1 to 10 may also be combined so that such a soft base material pretreated according to Step 3 and/or 4 (cleaning, degreasing, in the case of electrochemical and electrical systems: oxides removed) is used, and the particles or the coating material is applied onto the base material at such a high pressure that the particles or the coating material fully or partially penetrate into the base material, cover the latter and adhere in the base material. In this way (as described above) the surface geometry of the base material and of the particles of the coating material are optimally adapted to one another so that a firmly adhering connection is produced. This adhesion is then so strong that the particles on the base material can only be removed again by applying additional forces.

The following may, for example, be used as soft base material in this case:
maximally pure, optionally heat-treated or warmed/heated, foil containing aluminum, preferably highly pure aluminum with a purity of >99.00 wt % aluminum.
Foil containing copper, preferably highly pure copper with a purity of >99.00 wt % copper.

The particles of the coating material may be taken up by an, e.g., slightly tacky calender surface and transferred onto the base material, for example, mechanically, for example, by rolling. The tackiness required for this is comparable with a household rubber fluff roller or with self-adhesive paper (known by the name “Post-it”).

The particles of the coating material may, for example, be lithium iron phosphate and other known active materials for anodes and cathodes in batteries containing lithium. Such materials are widely known for their high hardness so that they can penetrate easily into soft materials and are most suitable for methods as described above.

As methods of applying the particles onto the base material, the methods mentioned above under point 10 may be possible, preferably dry spraying and/or pressing or calendering the coating applied wet, for example, by spreading or screen printing, or dry, if necessary under pressure, for example, 50 to 500 bar, preferably 200 to 400 bar.

According to another example, electrochemical cells such as batteries, fuel cells, electrolysis cells, electrochemical measuring cells are produced according to the aforementioned method. The electrode materials of the anode and/or cathode are coating materials containing particles. In this case the electrical lead, containing or consisting of, for example, platinum, gold, palladium, nickel, lead, carbon, including carbon fiber material, graphite film, vitreous carbon, aluminum, zinc, copper, titanium, zirconium, vanadium, tantalum, noble metal-coated titanium, in which case the noble metal may, for example, be platinum, ruthenium or a platinum-iridium alloy, is the base material. That is to say, it is also possible (depending on the application) to use any alloys of the aforementioned metals with one or more further elements of the periodic table of the elements as an electrical lead. Furthermore, the electrical lead may also be a coated material which contains the aforementioned metals in its coating, the coating touching the electrode material inside the electrochemical cell. For electrochemical cells, electrical leads consisting of a metal, for example, metal foil, which have not yet been curved or folded at a time before production of the respective cell as well as during and after the production process, are particularly preferred. The effect achieved by this is that local electrical contact resistances at and as a result of bends and folds of the metal foil are avoided. At such bends and folds, the material structure may be modified, but in particular the adhesion of the particles on the base material. For example, local detachment of particles from the base material may occur so that electrical contact resistances may be formed. In wound cells in which controlled curvature of the individual electrodes and cells is intended, fold-free curvature or winding is preferably carried out.

Particularly preferably, and as an alternative, such electrochemical cells are produced as follows, the separator and electrical lead having been cut to their final surface measurements before any coating. The, e.g., rectangular electrical lead is cut so that a lug used for the subsequent electrical connection protrudes beyond the electrical lead surface. (Later welding of this lug can therefore advantageously be avoided):
A) the separator, for example, which separates the anode and the cathode spatially, electrically and mechanically from one another and is itself used as an electrolyte or to receive the electrolyte, is used as starting material. The thickness of the separator is selected to be as small as possible to keep the cell resistance low. It should, however, be thick enough to be sufficiently mechanically stable and for an electrical short circuit between the anode and the cathode, or between their electrical leads, to be prevented. The porosity and nature of the material of the separator are selected such that it is sufficiently mechanically stable and, at the same time, ensures an ionic conductivity sufficient for the corresponding electrochemical cell. Examples of such commercially available separators are the product SEPARION® from Firma Evionic Industries AG or membranes of the brand name NAFION® from DuPont, which essentially consists of or contains sulfonated tetrafluoroethylene polymer (PTFE).

According to one example, this separator is respectively coated (in a similar way to that described above in the case of an electrical lead as base material) on both sides with the anode and cathode materials.

A separator may also contain an alkali metal carboxymethyl cellulose, the alkali metal preferably being lithium, sodium or potassium. The separator contains a known nonflammable or fire retardant inorganic material such as borate, phosphate, silicon dioxide, aluminum oxide or ceramic.

Furthermore, the separator may contain or consist of cellulose which may be impregnated with inorganic substances such as borate and/or phosphate to reduce the flammability. The cellulose contained in the separator is fully or partially reacted with lithium hydroxide according to a known method to form lithium carboxycellulose. At least in a separator containing lithium carboxycellulose, this may simultaneously function as an electrolyte in a secondary battery containing lithium, preferably a lithium ion battery, by the lithium acting as a charge carrier in the carboxycellulose.
B) Subsequently, the electrical lead, for example, containing aluminum and/or copper foil, is pressed or calendered under pressure, for example, 50 to 500 bar, preferably 200 to 400 bar, respectively, onto each side of the separator according to A). This results in an electrochemical cell, for example, a lithium ion battery.
C) Electrochemical cells according to B) may be electrically connected or stacked in any number in series or parallel. Series connection of a plurality of electrochemical cells by the anode of one cell respectively being assembled/stacked with the cathode of the next cell (as is known) results in a so-called stack. The electrical lugs of the anode and cathode are respectively connected to one another, for example, mechanically (for example, screwing, riveting) or with a material fit (for example, by welding) so that an anodic and a cathodic electrical supply are respectively formed, which are then led out through the housing or the outer foil (see D) and externally form the electrical contact of the electrochemical cell (for example, lithium ion battery).
D) The stack according to C) may be fitted in a housing or foil sufficiently mechanically stable for the respective purpose, electrically insulated, and preferably nonflammable, or with low flammability. If a foil (for example, an aluminum foil coated with plastic or ceramic) is used, this is preferably selected to be thick enough to prevent flammability of the aluminum in the respective application.

In this way, a particularly preferred material composite can be produced in the form of an electrochemical cell.

According to another example, the electrical leads for the cathode and anode may respectively be coated or produced separately with the material of the particle electrode described here and subsequently completed by assembly with any separator as discussed above to form an electrochemical cell. Any further possibilities for the manufacture of electrochemical cells from the anodic and cathodic material composite may be implemented.

Material composites may be used in all fields of coating technology. Examples which may be mentioned are parts with base materials consisting of metal, glass, wood, building materials or further inorganic or organic materials or biomaterials painted or coated with plastics or organic compounds. Furthermore, such base materials may be provided with inorganic coats such as glass and with metal coatings. Examples of such material composites may also be glasses coated with inorganic or organic fiber materials.

### EXAMPLES

### Example 1

A fold-free or previously mechanically smoothed aluminum foil with a chemical purity of 99.9 mass % and a thickness of 1 mm is first rubbed with sandpaper, the sand grains of which correspond on average to 50 μm. Preferably, the metal foil/aluminum foil is not folded at any time before the coating, but is always kept entirely smooth and fold-free. Furthermore preferably, the metal foil/aluminum foil is not folded at any time after the coating, but is always kept entirely smooth and fold-free.

Preferably, the metal foil/aluminum foil is not folded and/or curved at any point in time before the coating, but is always kept entirely planar, smooth and fold-free. Furthermore preferably, the metal foil/aluminum foil is not folded and/or curved at any time during and/or after the coating, but is always kept entirely planar, smooth and fold-free.

Instead of rubbing with sandpaper, any other method may be used, for example, sandblasting to generate such depressions on the surface of the aluminum foil. The aluminum foil is subsequently cleaned, degreased and dried by ethanol, acetone or isopropanol of “analytical” purity, and optionally with the aid of precision cleaning cellulose for electronic components, and coated by screen printing or spreading with an electrode compound with the following composition and particle sizes:

Approximately 8 mass % carbon black, average particle size: 100 nm

Approximately 5 mass % polyvinylidene fluoride

Approximately 88 mass % lithium titanate (Li₇Ti₅O₁₂), average particle size: 2 μm.

The polyvinylidene fluoride was converted into the liquid gel-like state beforehand by stirring in 1-methyl-2-pyrrolidine. The electrode coated in this way is subsequently dried, for example, by an IR dryer, and compressed with a line pressure of approximately 250 N/mm. The particles of the electrode compounds are incorporated into the depressions produced mechanically by rubbing with sandpaper on the surface of the aluminum. The electrode compound adheres visually very much better on the aluminum foil, i.e., no flaking of the electrode compound from the aluminum foil, compared to an aluminum foil not rubbed beforehand with sandpaper.

The same electrode is produced in parallel in the same way, but without the surface morphology of the aluminum being modified before coating. This electrode optically/visually shows flaking of the electrode mixture at various positions on the surface.

The particular technical effect of the material composite can be demonstrated in the following way:
Improved adhesion of the particle electrode on the electrical lead (here the metal foil) and the resulting reduction of contact resistances may be studied inter alia by the following methods: laser scanning microscopy, scanning electron microscopy, possibly in combination with four-point conductivity measurement and/or EDX (energy-dispensive X-ray spectroscopy). Particularly by making cuts at a right angle to the planar material composite, or to the electrode surface. With the aid of such cuts, it is possible to assess that the surface of the electrical lead, or of the base material, has been modified deliberately such that the particles of the particle electrode, or of the coating material, are thus inserted into the depressions on the surface of the electrical lead. Measurements of the contact area between the particles and the depressions in the surface of the electrical lead, or of the base material, over a defined area of, for example, 100 μm x 100 μm may, for example, be carried out by laser scanning microscopy or scanning electron microscopy. In the same way, for example, the diameter of particles or depressions can be determined. The improved function of the batteries, or electrochemical systems, produced therefrom may, for example, be monitored by electrochemical impedance measurement, by current or current-density measurement as a function of time with constant voltage, or by voltage measurement as a function of time with constant current strength or current density. Furthermore, new or used batteries may be dismantled and adhesion of the electrode layer on the electrical lead, or the coating material on the base material may be determined by conventional methods, for example, a bending test.

The electrodes produced in this way are used to produce lithium ion cells.

### Example 2

Production of the electrodes is carried out as described in Example 1. Instead of the aluminum foil, an approximately 0.05 to 5.0 mm, preferably 0.5 to 2.0 mm thick foil containing graphite, which may be mechanically flexible, is used. Such a graphite film, for example, the products SIGRAFLEX® or ECOFIT® F from SGL Carbon SE, as a starting material with sufficient electrical resistivity, for example, 9.0 Ωμm, is commercially available.

### Example 3

An aluminum foil with a chemical purity of 99.9 mass % and a thickness of 1 mm is first rubbed with sandpaper, the sand grains of which correspond on average to 50 μm, cleaned with ethanol which has a purity quality for analytical chemical purposes, and coated with graphite with an average particle size of 10 μm.

1-19. (canceled)

20. A material composite comprising a coating material having particles and a base material, wherein 1) the base material contains on its surface depressions which lead to a reduced thickness of the base material at the position of the depressions, 2) the depressions are deviations from a smooth plane surface of the base material, and 3) geometrical dimensions and/or shapes of the particles and the depressions are similar or match such that one or more particles fully or partially fit geometrically into the individual depressions or penetrate adheringly by a force and/or energy so firmly that the adhesion is at least partially based on mechanical forces between particles and base material.

21. The material composite as claimed in claim 20, wherein the geometrical surfaces of the particles are shaped or dimensioned, or are geometrically similar or match such that the particles on their surface either fit one another or are adheringly connected by the effect of force and/or energy so firmly that the adhesion is at least partially based on mechanical forces between particles.

22. The material composite as claimed in claim 20, wherein the particles cannot be separated from the base material without a nonzero force or energy contribution which may have the magnitude of the force of gravity.

23. The material composite as claimed in claim 20, wherein the diameter of the most frequently occurring particles is less than the most frequent diameter of the depressions in the surface of the base material.

24. The material composite as claimed in claim 20, wherein the diameter of the most frequently occurring particles is at least 1% or at least 5% smaller than the most frequent diameter of the depressions in the surface of the base material.

25. The material composite as claimed in claim 20, wherein the diameter of the most frequently occurring particles is at least 10% or at least 30% or at least 50% smaller than the most frequent diameter of the depressions in the surface of the base material.

26. The material composite as claimed in claim 20, wherein the geometrical shapes of the particles of the particle electrode and of the depressions in the surface of the base material are the same.

27. The material composite as claimed in claim 20, wherein the geometrical shapes of the particles and the depressions in the surface of the base material are identical and/or polygonal and/or spherical and/or hemispherical and/or elliptical and/or semi-elliptical.

28. The material composite as claimed in claim 20, wherein the geometrical shapes of the particles and the depressions in the surface of the base material are identical and/or triangular to n-gonal, where n may be any natural number and mathematical dimensions between individual vertices in the depression of the surface of the base material may be either the same and/or different to one another and/or may be connected to one another by any mathematical function.

29. The material composite as claimed in claim 20, wherein the geometrical shapes and the mathematical dimensions of the particles and of the depressions in the surface of the base material are similar such that respectively at least 99.99% or at least 80% or at least 50% or at least 20% or at least 10% of the surface of the depressions of the base material is touched by the surface of the particles.

30. The material composite as claimed in claim 20, wherein the particles and the depressions in the surface of the base material form a clip structure, the clip structure being characterized in that the inner diameter in the near-surface region of at least one depression is smaller than in the region of the same depression remote from the surface.

31. The material composite as claimed in claim 20, wherein the base material is an electrically conductive electrical lead of an electrochemical or electrical cell and the coating material contains at least one active material.

32. An electrochemical system, battery, fuel cell, electrolysis cell or double-layer capacitor containing a material composite as claimed in claim 20.

33. A method of producing a material composite which comprises a coating material containing particles and a base material comprising in chronological succession:
A) determining spatial dimensions and size distribution of the particles,
B) adapting and/or adjusting optimal particle size and shape as claimed in claim 20,
C) structuring the surface of the base material such that the particles of the particle electrode geometrically fit into the depressions of the surface of the base material,
D) cleaning the base material with a compatible cleaning agent and/or solvent and/or by a physical method,
E) drying the base material in a vacuum or in a protective gas atmosphere or in air and/or at elevated temperature,
F) preparing the coating material by mixing electrochemically active material, material containing carbon, and binder, to form a homogeneous mixture,
G) coating the base material structured according to step c) with the coating material containing particles adapted according to steps a) and b), the base material being at the same temperature or at a higher temperature in comparison to the coating material,
H) drying the coated base material, and
I) spatially compressing the layer produced according to step G or H, which may be at any temperature.

34. The method of claim 33, wherein the base material is an electrically conductive electrical lead of an electrochemical or electrical cell and the coating material contains at least one active material.

35. The method of claim 34, wherein the base material is an electrical lead and the coating contains or exclusively consists of active material and/or is a mixture containing carbon, which optionally contains carbon black and/or graphite and which optionally contains a binder and/or any plastic and/or a solvent.

36. The method of claim 34, wherein the surface of the electrical lead is coated with an adhesion promoter directly before step G.

37. The method of claim 32, wherein a base material is used which is so soft, and the particles or the coating material are applied onto the base material at a pressure so high that the particles or the coating material penetrate fully or partially into the base material and adhere in the base material.
